(19) United States
(12) Patent Application Publication
(10) Pub. No.: US 2013/0098712 A1
(43) Pub. Date: Apr. 25, 2013

(54) CONTROL FOR LIFT FOR POOL

(71) Applicants: William Svendsen, Sherwood, OR (US); Scot Newport, Canby, OR (US)

(72) Inventors: William Svendsen, Sherwood, OR (US); Scot Newport, Canby, OR (US)

(73) Assignee: S.R. SMITH, LLC, Canby, OR (US)

(21) Appl. No.: 13/300,498

(22) Filed: Nov. 18, 2011

Related U.S. Application Data
(60) Provisional application No. 61/550,319, filed on Oct. 21, 2011.

(51) Int. Cl. B66B 1/14; B66B 5/02; B66B 3/00

(52) U.S. Cl. 187/381; 187/390; 187/393

(57) ABSTRACT

A pool lift control provides functional operation control of pool lift devices with access control, low power indicator that preserves battery by attempting determination of whether someone is nearby to hear the low battery alert, and emergency stop/panic indication functionality.

### BACKGROUND OF THE INVENTION

This invention relates to pool lifts, and more specifically to an improved pool lift control and system.

Pool lifts are designed to assist anyone who has problems entering or exiting a swimming pool or spa or the like. Such lifts typically employ a chair or some other type of seating or holding arrangement to allow a user to be temporarily secured in the lift while moving the user into or out of the pool or spa. Such lifts enable individuals with disabilities or mobility impairments to have universal access to any type of swimming pool or spa, and may be powered to provide lifting and turning motions to transport the user.

Such pool lifts require operation controls and improved controls are desirable. The pools and lifts are often in an unstaffed area and it can be important to control access to the operation of the lifts. Typically the lifts are battery operated, and tampering with or theft of the batteries can sometimes be an issue. Also, since the operation is battery based, easy determination of the battery state is desirable to minimize the time and effort required to check battery status and replace or recharge when necessary.

### SUMMARY OF THE INVENTION

In accordance with the invention, a pool lift control system employs access control, emergency stop and alert features and battery level indication for operation of pool lifts.

Accordingly, it is an object of the present invention to provide an improved pool lift control system.

It is a further object of the present invention to provide an improved pool lift control system with access control.

It is yet another object of the present invention to provide an improved pool lift system with battery status reporting capability.

It is yet another object of the present invention to provide an improved pool lift system with alerting features to allow users to indicate emergency situations.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIGS. 1A and 1B are front and side views of a lift control in accordance with the present disclosure;

FIG. 2 a closer view of the control module portion of the device in the area of arrow A of FIG. 1A;

FIG. 3 is an end view of the interface of the battery module;

FIG. 4 is an end view of the interface portion of the control module;

FIG. 5 is a close up view of a portion of the locking components of the device;

FIGS. 6 and 7 are close up views of a portion of the locking components of the battery module;

FIG. 8 is a perspective view of the battery and control module locking components when engaged with one another;

FIG. 9 is a rear perspective view of the lift control when engaged with a mounting bracket;

FIG. 10 is a partial perspective view of the lower portion of bracket 47, bracket tabs 78 may be observed in further detail;

FIG. 11 is an end view of the control module;

FIG. 12 is a view of a wireless remote control;

FIG. 13 is a side view of a key for operational control of the device;

FIG. 14 is an end view of the key of FIG. 13; and

FIG. 15 is a diagram of the wireless communication link feature.

### DETAILED DESCRIPTION

The system according to a preferred embodiment of the present invention comprises a system for operation of a pool lift.

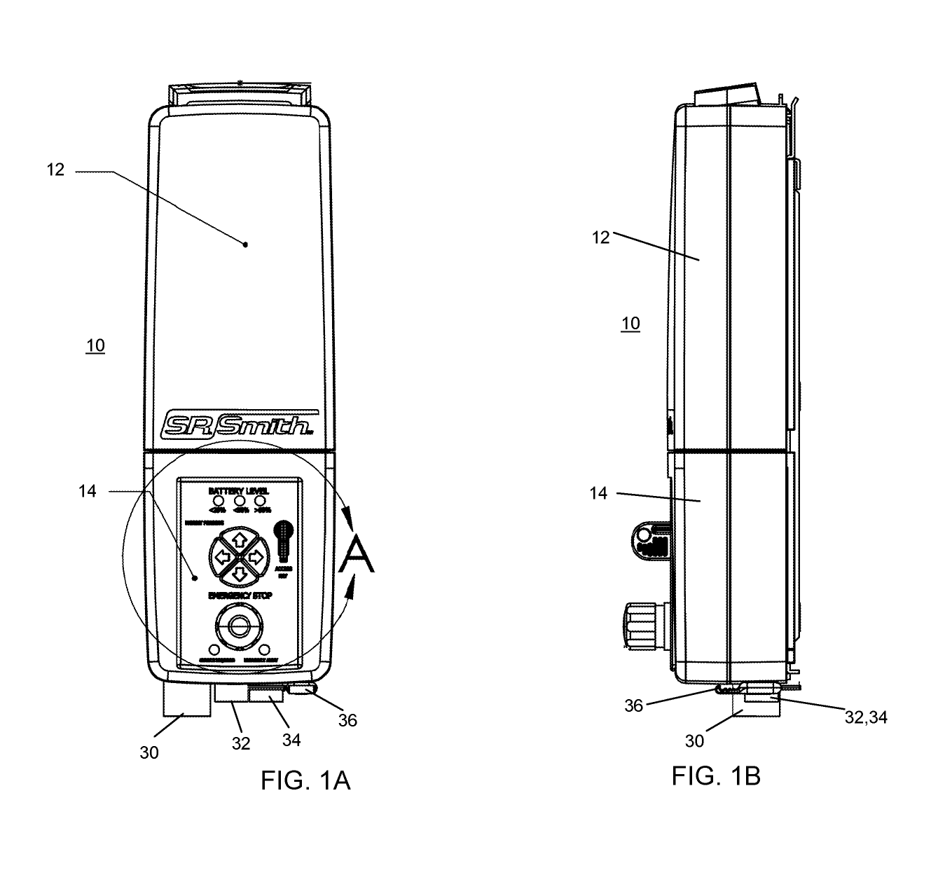

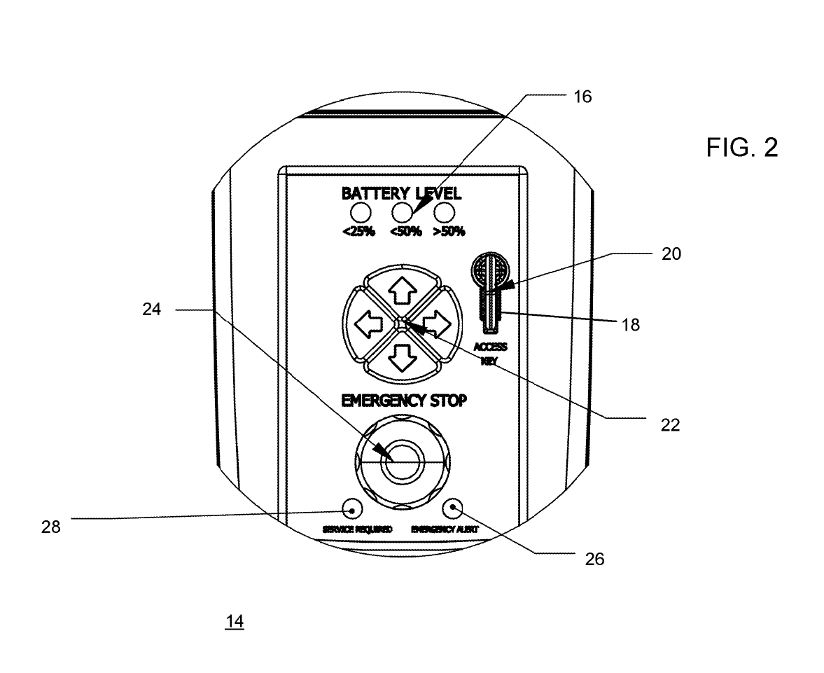

Referring to FIGS. 1A and 1B, front and side views of a lift control 10, the control is configured as 2 main components, a battery compartment 12 and a control module 14, adapted for cooperative engagement with one another. The control module 14 provides controls and functional indicators to assist in use. FIG. 2 is a closer view of the control module 14, which includes battery level indicators 16, which in the preferred embodiment comprise 3 lighted indicators showing greater than 50% battery level, less than 50% battery level, and less than 25% battery level. An access key receiving slot 18 is provided for insertion of a key 20 (discussed further hereinbelow) to allow operation of the device to be keyed so that only authorized persons may operate the pool lift. This can be useful in, for example, hospitality industries and unstaffed pools, where a guest of a property or authorized pool user can check out a key to allow use of the lift, but other unauthorized users are prevented from operating the device.

Motion controls 22, which are in the form of depressible arrow keys, provide directional control of the lift operation, giving up, down, left and right turning motion of a pool lift chair, for example, to govern movement of the lift chair to enable a person to be lowered into the pool from the pool deck or lifted out of the pool. A separate emergency stop control 24 is also provided, wherein activation of this control will cause lift operation to cease. Additional indicators, such as emergency alert 26 and service required 28, are also present.

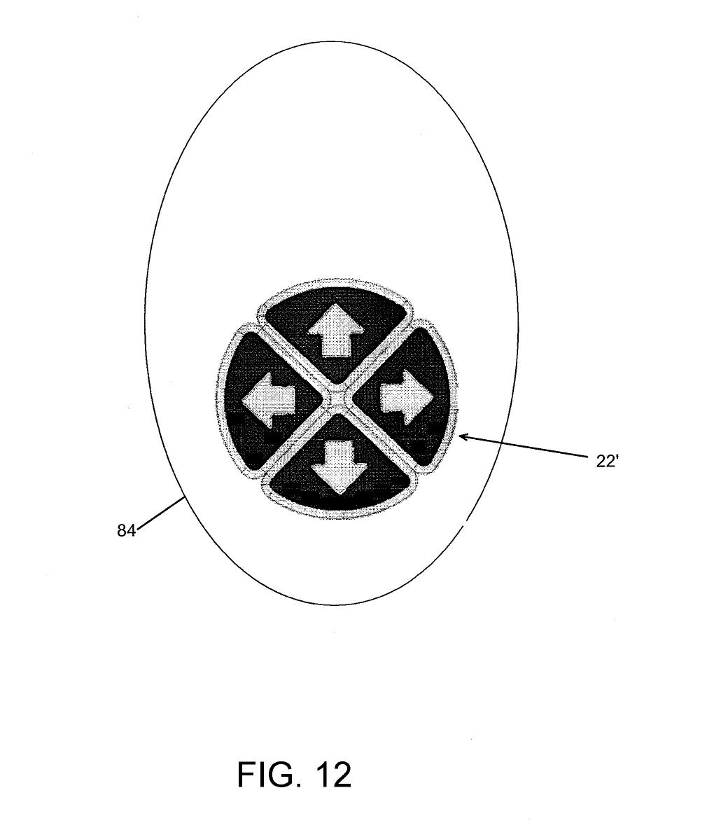

Referring to FIG. 12, a view of an exemplary remote control, a hand held remote module 84 may also be provided with motion control keys 22′ for movement control corresponding to the motion controls 22, but adapted for use by a person in the pool, or when riding the lift, of a distance away from the main control module. A panic button, not shown, may also be provided. The remote module can be wired to the controller or wireless, depending on the requirements of the particular installation.

Referring back to FIG. 1, Cable connectors 30, 32 and 34 allow control and power cables to be attached to the control 14 module, to provide power and control/sensing between the lift control and the pool lift actuator. A data port 36 enables connection to obtain operational and diagnostic data from the control module. The data port is a USB type port in a particular embodiment. The entire unit 12 and connections are suitably waterproof for use in a pool environment.

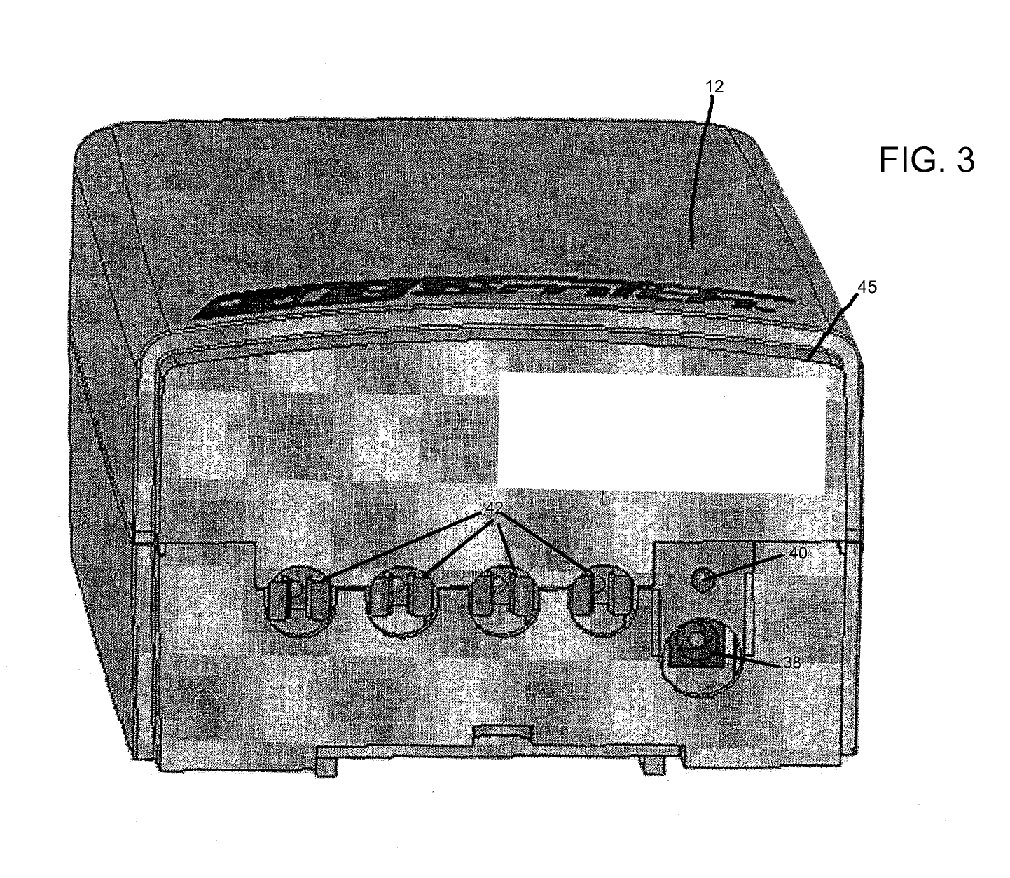

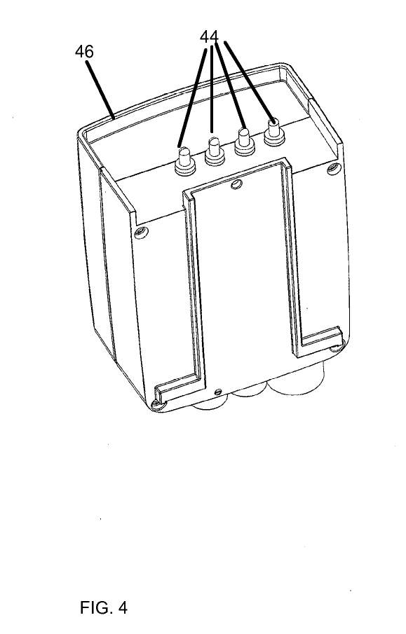

Referring to FIGS. 3 and 4, end views of the interface portions of the battery module 12 and control module 14, battery module 12 includes a charging socket 38 with corresponding charge indicator 40 (for showing the charge status when charging), and four power connectors 42, in the form of spring biased receiving sockets, which engage with corresponding power connectors 44, in the form of connector posts, on control module 14 when modules 12 and 14 are interconnected, to provide battery power to the control module (and ultimately from the control module to the lift device itself). Modules 12 and 14 are provided with corresponding mating profiles 45, 46 so that the two modules can be joined together with a watertight seal. Profile 45 is of slightly lesser dimensions so as to fit in close engagement with the overhanging configuration of profile 46.

When the battery module is removed for charging, a charger is attached to socket 38, and indicator 40 will denote the charge state, e.g., red for discharged, green for fully charged. Other indications can be provided with different color or flashing patterns to denote intermediate levels of charge.

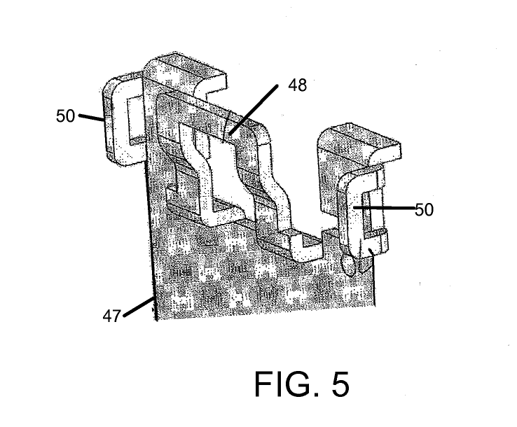

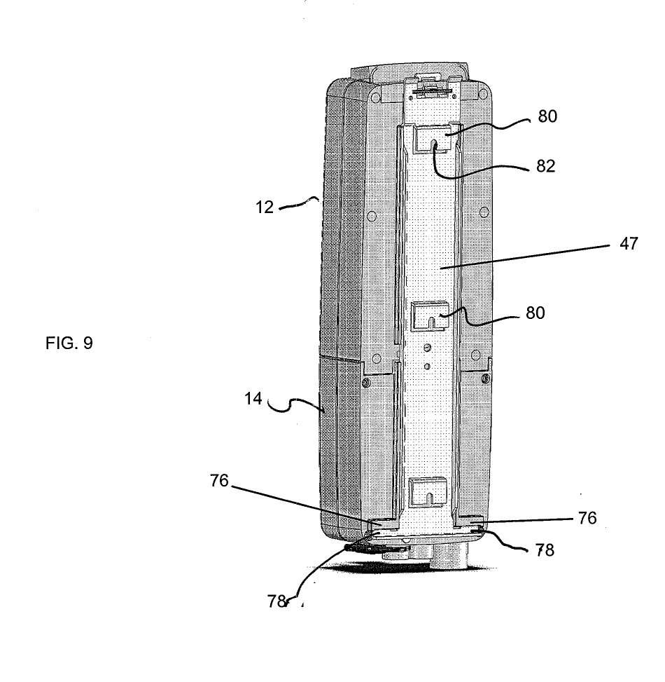

Referring to FIG. 5, a close up view of a portion of the locking components of the device, and FIG. 9, a rear perspective view of the lift control, the back side of the control and battery modules interface with a bracket 47 that extends substantially the length of the control module and battery module. Bracket tab receiving portions 76 are formed at a lower end of the control module to engage with corresponding bracket tabs 78 which fit within the receiving portions 76 when the lift control is lowered onto the bracket. Raised mounting tabs 80 extend rearwardly somewhat and are spaced along the back of bracket 47, with fastener receiving slots 82 defined therein, so that the bracket can be mounted to a support member at the mounting location for the lift control.

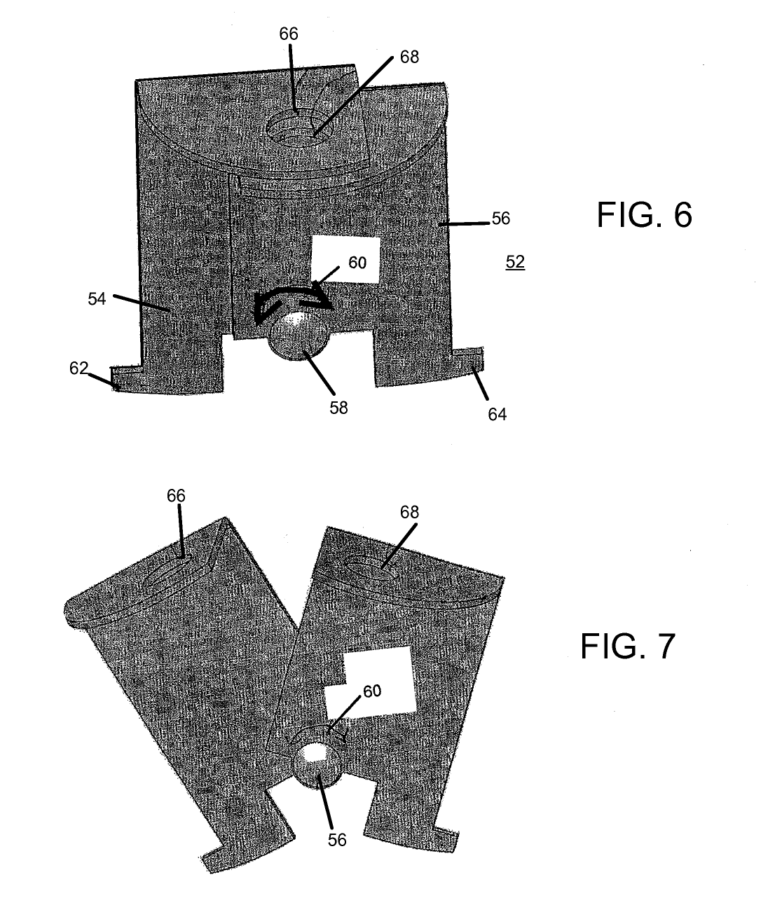

The top end of the bracket 47, shown by FIG. 5, forms central tab 48 and left and right side tabs 50, which define openings in the tabs. Mounted to the upper end of the back face of battery module 12, is a lock member 52, illustrated in FIGS. 6-8, which comprises left and right legs 54, 56, mountable to the battery module via pivot connector 58, allowing rotational movement of the left and right legs about the pivot connector as shown by arrow 60, enabling movement between a locked position (FIG. 6) and an unlocked position (FIG. 7). The legs include outwardly extending feet portions 62, 64, and lock receiving holes 66, 68 at an upper portion of the legs. When in the locked position (FIG. 6), holes 66, 68 align and are adapted to receive a lock therethrough.

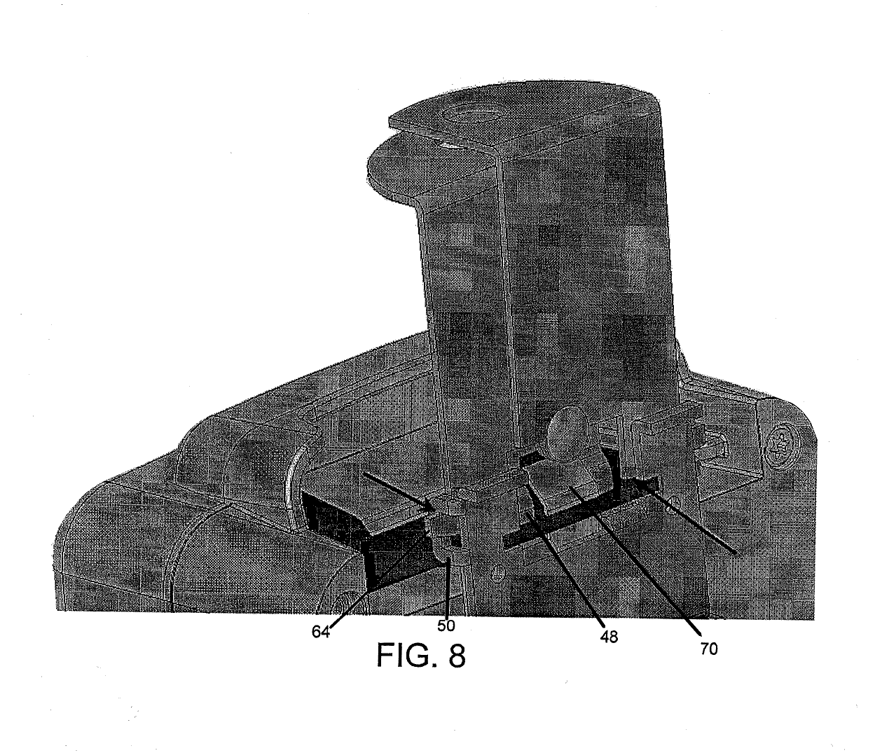

Pivot connector 58 also suitably mounts the lock mechanism to the battery module 12 (FIG. 8), and when the legs 54, 56 are moved to the locked position of FIG. 6, the outwardly extending feet portions pass through the openings in left and right tabs 50, to engage the feet and tabs. A corresponding central tab 70 is provided on the battery module to be received in the opening defined by tab 48, whereby the cooperation of the feet 62, 64, tab 50 openings, central tab 70 and tab 48 opening secure the battery and control modules to one another. A lock may be inserted through the openings 66, 68 when they are aligned with one another, to lock the battery and control modules together so that only authorized persons may remove the battery from the control module.

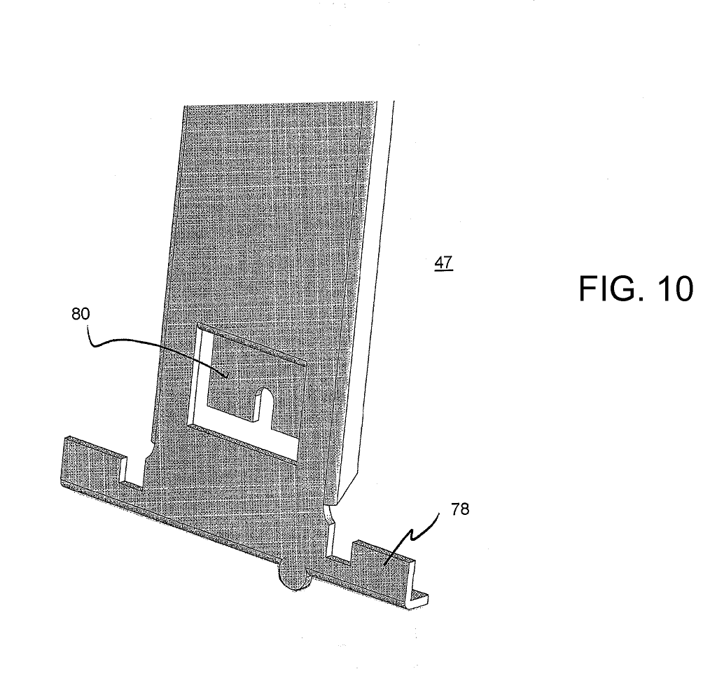

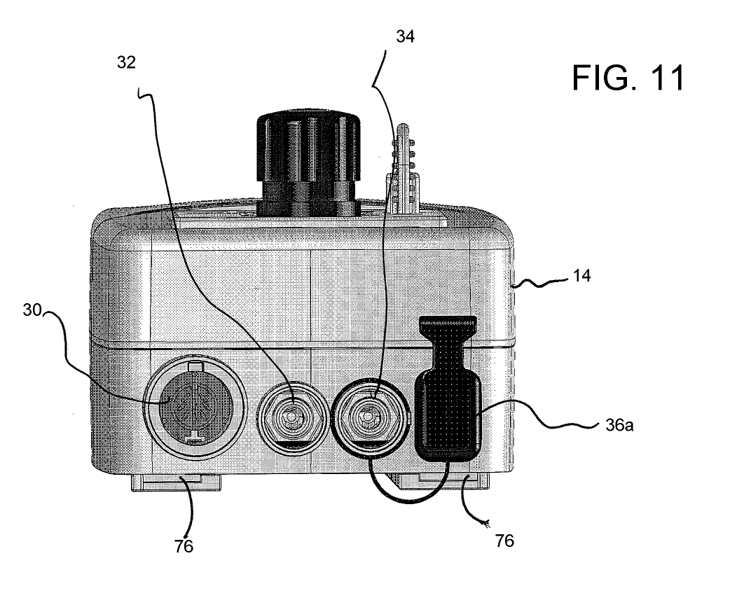

With reference to FIG. 10, a partial perspective view of the lower portion of bracket 47, bracket tabs 78 may be observed in further detail. FIG. 11, an end view of the control module 14, illustrates the bracket tab receiving portions 76, suitably defining slots that the tabs 78 fit within.

Still referring to FIG. 11, the cable connectors 30, 32 and 34 are visible, where connector 30 is configured as an 8 line control socket and connectors 32 and 34 are power connectors. Data port 36 is illustrated with a cover 36a to provide environmental shielding to the data connection when not in use.

In the case where remote module 84 is a wired control, the data cable from the module plugs into connector 30 to provide control signaling. If remote module 84 is wireless, wireless communication components are provided in the remote 84 and control module 14.

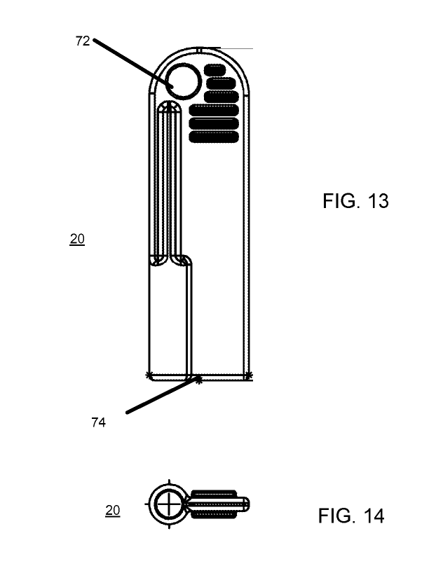

FIG. 13 is a side view and FIG. 14 is an end view of a key 20 which is provided with a key ring receivingopening 72 and is shaped and sized to be correspondent to the shape and size of access key receiving slot 18 in the control module. They key includes a magnet 74 at one end in the preferred embodiment, and the magnet cooperates with a corresponding reed switch inside the control module, such that insertion of the key 20 into slot 18 of the control module will activate the reed switch to indicate that operation of the control module is allowed. By this, use of the lift may be governed so that only authorized or approved persons can operate the lift, which may be desirable in cases where pools are operated in a generally unattended mode.

In operation, control module includes electronics to provide a non-operation feature so that operation of the lift will not be permitted if certain safety conditions are not met. For example, if a particular lift requires stabilizer arms to be deployed before operating, the control module will sense whether the stabilizers are fully deployed and locked into position (via detent switch sensing provided by control cables and corresponding logic in the control module) and will prevent operation if the arms are not deployed.

The control module employs visual indicator 16 to show battery charge status, wherein the indicator 16 suitably comprises LEDs. The operation of the LED display has a sleep mode to conserve power and will illuminate when any of the control box switches/buttons are activated or when the hand controller is used.

An operation cycle counter is implemented within the control module to count the number of cycles the lift has made, wherein after a predetermined number of cycles, service required indicator 28 is illuminated to indicate that maintenance service is required.

The control module further includes a sounder capable of delivering a high volume (e.g., 85 db) continuous panic alarm (for example, for 60 seconds) when activated. Activation may be accomplished by depressing a panic button or by depressing any 2 buttons simultaneously on the control module (or, correspondingly, by simultaneously pressing any 2 of the motion controls 22′ on the remote 84).

Operation of the emergency stop button 24 (by depressing it) will result that immediately stops all movement of the lift. The emergency stop button is suitably red in color and is marked “Emergency Stop”. Releasing the emergency stop button, by lifting it, allows the lift to resume normal operation. When the emergency stop button is depressed an emergency alert may be trigged that sounds for a duration of, for example, 60 seconds, and repeats for additional cycles of 60 seconds after a pause of, for example, 5 seconds, if the button is still depressed.

In the event that the battery level becomes low (the particular level that is considered ‘low’ can be chosen depending on the battery discharge profile of any particular configuration of batteries), a low battery warning, such as a tone on preset timing sequence (for example, of one tone every 30 seconds) is provided. A proximity sensor, such as motion sensor is optionally provided to the device such that the low battery warning tone is sounded only when nearby motion is detected (which would indicate that persons are nearby), so that battery power is preserved and not wastefully drained by sounding an alert when there is no one nearby who might hear the alarm.

Referring to data port 36, which in a preferred embodiment comprises a USB port located for prevention of water intrusion (further assisted by cover 36a), on access to the port, for example by plugging a USB data stick into the USB connector, the control module will download operation information to the USB stick, including lift cycle data and battery level data that is monitored by the control module. The cycle information is maintained on an ongoing basis. The downloading of data is also correlated with the service required indicator 28 Once the USB stick has downloaded the data the service required indicator light 28 may be extinguished, until the next time that the number of operation cycles (or other events) designate a service required state.

In addition to power from battery module 12, provision may be made for connection to an optional power source, which can include solar power source or other external power.

A solar cell power source may also provide a trickle charge to prevent the battery from fully discharging and failing.

The external case housing of the battery and control modules may be constructed of durable UV and impact resistant plastic.

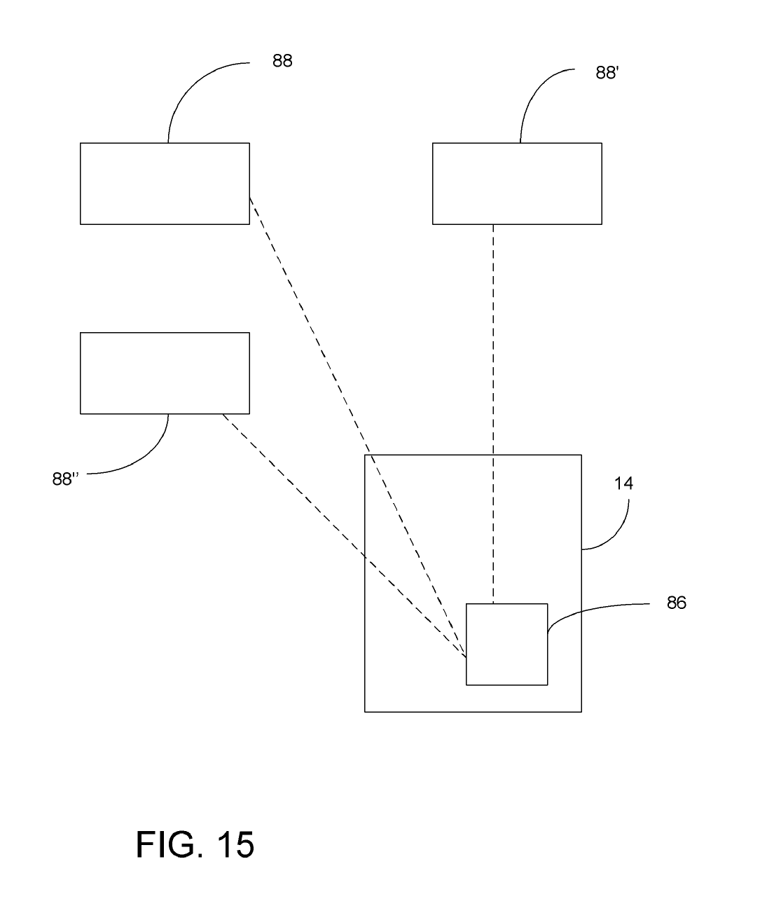

An additional feature provided is a wireless communication link between the emergency alert system and the controller system. When the emergency stop is effected, for example by pressing the emergency stop button or any two buttons in the hand held remote, a wireless signal is transmitted that causes a remote sounder or strobe or other warning device to be activated. The remote warning device can be located away from the pool, such as in an office. Referring to FIG. 15, a diagram of the wireless communication link, the wireless module 86 is contained within the controller, and includes operational logic, whether hardware or software implemented, to, when an emergency stop is effected or the two button panic signal is activated, generate a wireless signal, whether optical or radio based, which is received by the remote receiver 88, to generate a warning at the remote. In a first embodiment, the remote 88 is simply a receiver with no two-way communication ability. In a further embodiment, two way communication is provided between the remote and the control box at the pool to ensure the remote is within range and that communication is taking place between the two so that any emergency signal will be received at the remote. With this system, emergency altering can be provided in situations where there is no pool attendant on duty, like a hotel. The sounder or strobe would be located in the office to alert the staff that there is an issue. Plural additional remote modules 88′, 88″, etc., may be provided, to have multiple alert locations to enable emergency alerts to be received at separate locations. In the preferred embodiment, the wireless link comprises a radio link, but optical links may also be employed. Further, wired links can be provided to remote alert receivers, either in combination with wireless links or alone. The remote modules 88 can include audio or visual indication, for example.

Accordingly, the control provides functional operation control of pool lift devices and provides easy access to the unit in case of replacement and provides access to the rechargeable battery module. The device controls the lifting and turning motions of the lift via cable attachments with water tight cable connections. The directional control of the lift is operated via a hand controls for up and down motions, one set is for left and right turning motions of the lift.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A lift control for a pool lift, comprising:
a lift operation control device for receiving operational function commands from a user; and
an access control mechanism for disabling response of the pool lift to operational function commands

2. The lift control according to claim 1, wherein said access control mechanism comprises an access key receiving slot and a corresponding key, wherein one of said access key receiving slot and said key comprise a reed switch and the other comprises a magnet for activation of said reed switch when said magnet is placed in proximity thereto, for enabling response of the pool lift to operational function commands.

3. The lift control according to claim 1, further comprising, a remote controller with plural directional control members for operation by the user to provide said operational function commands, wherein said lift control further comprises a panic indicator responsive to simultaneous actuation of at least two of said directional control members.

4. The lift control according to claim 1, further comprising, a power level indicator for reporting a power level of a power source for the lift operation controller, wherein said power level indicator includes a proximity sensor for determining when persons may be nearby and for deferring reporting low power mode when said proximity sensor indicates that persons may not be nearby.

5. The lift control according to claim 4, wherein said power level indicator comprises an audible enunciator to indicate a low power condition.

6. The lift control according to claim 1, further comprising a panic alert indicator for alerting to a panic situation indication.

7. The lift control according to claim 6, wherein said panic alert indicator comprises at least one remote module and a communication link between the lift control and the remote module for communicating the panic situation indication to the remote module.

8. The lift control according to claim 7, wherein said communication link comprises a wireless communication link.

9. A lift control for a pool lift, comprising:
a lift operation controller for operating the pool lift based on operational function commands received from a user; and
a power level indicator for reporting a power level of a power source for the lift operation controller, wherein said power level indicator includes a proximity sensor for determining when persons may be nearby and for deferring reporting low power mode when said proximity sensor indicates that persons may not be nearby.

10. The lift control according to claim 9, wherein said power level indicator comprises an audible enunciator to indicate a low power condition.

11. The lift control according to claim 9, further comprising a remote controller with plural directional control members for operation by the user to provide said operational function commands, wherein said lift control further comprises a panic indicator responsive to simultaneous actuation of at least two of said directional control members.

12. The lift control according to claim 11, wherein said panic alert indicator comprises at least one remote module and a communication link between the lift control and the remote module for communicating the panic situation indication to the remote module.

13. The lift control according to claim 12, wherein said communication link comprises a wireless communication link.

14. A lift control for a pool lift, comprising:
a lift operation controller for operating the pool lift based on operational function commands received from a user; and
a controller with plural directional control members for operation by the user to provide said operational function commands,
wherein said lift control further comprises a panic indicator circuit responsive to simultaneous actuation of at least two of said directional control members.

15. The lift control according to claim 14, wherein said panic indicator circuit stops movement of the pool lift in response to said simultaneous actuation of at least two of said directional control members.

16. The lift control according to claim 15, further comprising, a power level indicator for reporting a power level of a power source for the lift operation controller, wherein said power level indicator includes a proximity sensor for determining when persons may be nearby and for deferring reporting low power mode when said proximity sensor indicates that persons may not be nearby.

17. The lift control according to claim 16, wherein said power level indicator comprises an audible enunciator to indicate a low power condition.
